(19) United States
(12) Patent Application Publication
(10) Pub. No.: US 2026/0017803 A1
(43) Pub. Date: Jan. 15, 2026

(54) DIGITAL IMAGE PROCESSING WITH AUTOMATED IMAGE BOUNDARY DETECTION

(71) Applicant: Purdue Research Foundation, West Lafayette, IN (US)

(72) Inventors: Wei Xu, West Lafayette, IN (US); Qi Guo, West Lafayette, IN (US); Junjie Luo, West Lafayette, IN (US)

(21) Appl. No.: 19/266,591

(22) Filed: Jul. 11, 2025

Related U.S. Application Data
(60) Provisional application No. 63/670,218, filed on Jul. 12, 2024.

(51) Int. Cl. G06T 7/13; G06T 7/11; G06T 7/90

(52) U.S. Cl. CPC G06T 7/13; G06T 7/11; G06T 7/90; G06T 2207/10024; G06T 2207/20081; G06T 2207/20084

(57) ABSTRACT

Digital image processing with automated image boundary detection. A two-stage hybrid computer-implemented neural network architecture for a digital image processor includes an initialization stage having a convolutional neural network architecture and a refinement stage having a feedforward transformer encoder. The convolutional neural network architecture generates initial field-of-junctions parameters for overlapping image patches of an input image. The feedforward transformer encoder refines each of the initial field-of-junctions parameters to output refined field-of-junctions parameters for each of the image patches and generate a boundary map and a color map for each image patch. A multi-stage training scheme is used to optimize the parameters of the neural network architecture. The initialization stage is trained using the patch reconstruction loss. Then, the refinement stage is optimized by using a mean squared error loss function to directly supervise the initial field-of-junctions parameters, and then using a comprehensive image reconstruction loss to evaluate the loss in a single step.

### CROSS-REFERENCE TO RELATED APPLICATIONS

This application claims the benefit of provisional U.S. Patent Application No. 63/670,218 filed Jul. 12, 2024, the contents of which are incorporated herein by reference.

### STATEMENT REGARDING PRIOR DISCLOSURES BY AN INVENTOR OR JOINT INVENTOR

The following disclosure is related to the disclosures made herein and was made by one or more inventor or joint inventor of the present invention:

Wei Xu, Junjie Luo, and Qi Guo, CT-Bound: Robust Boundary Detection from Noisy Images Via Hybrid Convolution and Transformer Neural Networks, submitted to Cornell University's open-access archive, arXiv.org, on Mar. 25, 2024, and submission revised Jun. 25, 2024, available at https://doi.org/10.48550/arXiv.2403.16494, the contents of which are incorporated by reference herein.

### BACKGROUND OF THE INVENTION

The invention generally relates to the field of computer-implemented digital image processing, and more particularly to digital image processing systems, computer-implemented neural networks for the digital image processing, and methods for automated image boundary detection in digital image processing and for training the neural networks.

In the field of computer-implemented digital image processing, detecting boundary structures from very noisy images is a common and challenging computer vision problem. There have been many applications that require boundary detection from images with very low light levels, such as medical imaging, manufacturing, and autonomous navigation, among others. Some conventional image boundary detection methods rely on luminance changes and implement methods of local boundary detection, global boundary refinement, or deep learning boundary detection.

In local boundary detection methods, the first step is typically using specially designed filters to locate local responses of image boundaries. The filters either maximize the detectability and localization accuracy of the boundaries under noise, (e.g., Roberts cross operator, Canny detectors, Laplacian detectors, and perfect matching filters), or are sensitive to the direction of the image boundaries (e.g., Sobel filters, gaussian quadrature pairs, and steerable filters). To robustly detect boundaries under non-ideal edges, sophisticated filters have been developed that are non-linear or operate in multiple scales. However, these classic methods based on local patches are found to be insufficient when the noise of the image is severe and have limited visual information to confidently determine the edges from the receptive field of a single filter. In this case, image smoothing is also not a solution as the smoothing operation will cause faint or fine boundary structures to be indistinguishable.

In global boundary refinement methods, boundaries in natural images are usually piece-wise smooth. Some conventional algorithms refine a global boundary map from locally detected boundaries by regularizing the curvature (e.g., the squared curvature or total curvature) along the boundary. In addition, some methods incorporate the intuitive restriction that the neighboring boundary maps must agree by enforcing neighboring consistency. These global refinement methods are typically iterative and thus often have a high computational complexity.

Deep learning boundary detection systems utilize deep neural networks that fuse the two steps, local boundary detection and global boundary refinement, into an end-to-end architecture learned from data. These deep learning methods directly output global boundary maps in either nonparametric ways or parametric ways. These methods typically outperform traditional, non-learning-based edge detection methods. Another deep learning-based method combines field-of-junctions (FoJ) representation with deep neural networks. This method is designed for detecting complicated, fine boundary structures and outputting more in-depth boundary information, such as edge-aware distance maps, from noisy images.

One example of a deep learning model is the Vision Transformer (ViT) model described by Dosovitskiy et al. in “An Image is Worth 16×16 Words: Transformers for Image Recognition at Scale” (available at https://doi.org/10.48550/arXiv.2010.11929). The Vision Transformer splits an image into patches and provides the sequence of linear embeddings of these image patches as an input to a Transformer. The image patches are treated the same way as tokens (words) in an NLP application. The model is trained on image classification in supervised fashion on larger datasets of 14 M-300 M images.

Nevertheless, although image boundary detection has been broadly studied since the early stage of computer vision, the accuracy of current conventional best boundary detection algorithms is still unsatisfactory when the input images have a very low light level. Therefore, it would be desirable to have a digital image processing system that provides more accurate boundary detection of digital images with high noise at faster speeds than are currently available.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, two-stage hybrid computer-implemented neural network architectures for digital image processors, digital image processors, computer-implemented methods of estimating a boundary in a digital image, and methods of training a two-stage hybrid computer-implemented neural network architecture.

According to a nonlimiting aspect, a two-stage hybrid computer-implemented neural network architecture for a digital image processor includes an initialization stage having a convolutional neural network architecture and a refinement stage having a feedforward transformer encoder. The convolutional neural network architecture is configured to generate initial field-of-junctions parameters for each of a plurality of image patches of an input image. The feedforward transformer encoder receives the initial field-of-junctions parameters and refines simultaneously each of the received initial field-of-junctions parameters to output refined field-of-junctions parameters for each of the image patches.

According to another nonlimiting aspect, a digital image processor includes the two-stage hybrid computer-implemented neural network architecture.

According to still another nonlimiting aspect, a method of training the two-stage hybrid computer-implemented neural network architecture includes training the initialization stage using patch reconstruction loss, and after training the initialization stage, optimizing the refinement stage to generate inputs for the field-of-junctions parameter estimations by supervising the field-of-junctions parameter estimations directly with a mean squared error loss function and implementing a comprehensive image reconstruction loss in a single step to fine-tune the feed-forward transformer encoder to improve the field-of-junctions parameter estimations.

According to yet another nonlimiting aspect, a computer-implemented method of estimating a boundary in a digital image includes dividing an input image into a plurality of overlapping image patches, using a convolutional neural network architecture, generating for each image patch initial field-of-junctions representations comprising initial vertex locations, initial edge angles, and initial color parameters. For each image patch, the initial field-of-junctions representations are converted into feature vector representations, positional encoded feature vectors are generated by applying positional encoding comprising adding a positional vector to the feature vector representations to incorporate positional information of each image patch, and refined image patches are generated by providing all the positional encoded feature vectors to a feedforward transformer encoder to simultaneously refine boundary consistency among the image patches globally, adjust unnatural boundary estimations, and calculate refined color parameters for each image patch.

Technical aspects of two-stage hybrid computer-implemented neural network architectures, digital image processors, and methods as described above preferably include the ability to increase the edge detection accuracy of field-of-junctions (FoJ)-based methods at significantly faster speeds, produce boundary and color maps on real captured images without extra fine-tuning, and/or produce real-time boundary map and color map videos at rates of multiple frames per second.

These and other aspects, arrangements, features, and/or technical effects will become apparent upon detailed inspection of the figures and the following description.

### BRIEF DESCRIPTION OF THE DRAWINGS

FIG. 1 diagrammatically illustrates a network architecture of a digital image processing system according to a nonlimiting embodiment of the present invention.

FIG. 2 is a field-of-junctions (FoJ) generalized local boundary representation for an image patch used in the digital imaging processing system.

FIGS. 3A-3F are a series of images illustrating the effect of refinement and boundary selection using the digital image processing system of FIG. 1.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The present invention relates generally to a digital image processing system 10 having robust and fast boundary estimation and a method for interpreting noisy images. The method is implemented on one or more computers configured with computer software instructions that cause the computer(s) to execute the method. In general, the method breaks the process of boundary estimation into two tasks: local detection and global regularization. First, a parametric representation of boundary structures is estimated using only the input image within a small receptive field. Then the boundary structure is refined in the parameter domain without accessing the input image. In some embodiments, the system 10 uses a hybrid convolution and transformer neural network. The method decomposes the process of estimating boundaries into two tasks: local detection and global regularization of image boundaries. In one example embodiment, during the local detection, the model uses a convolutional architecture to predict the boundary structure of individual image patches in the form of a pre-defined local boundary representation, the field-of-junctions (FoJ). Then during global regularization, the model uses a feed-forward transformer architecture to globally refine the boundary structures of each image patch to generate simultaneously an edge map and a smoothed color map.

In investigations leading to the invention, the system 10 and method was demonstrated to make it possible for a part of the network to be easily trained using naive, synthetic images and still generalized to real images, and the entire architecture was demonstrated to be computationally efficient as the boundary refinement is non-iterative and not in the image domain. Analysis showed that the system 10 and methods of the present invention are capable of outperforming conventional edge detection algorithms on very noisy images and also increasing the edge detection accuracy of FoJ-based methods while having a 3-time speed improvement. The investigations also showed that the system 10 and methods of the present invention are capable of producing boundary and color maps on real captured images without extra fine-tuning and real-time boundary map and color map videos at up speeds of to ten frames per second.

The investigations also demonstrated that the digital image processing system 10 is capable of providing robust boundary detection from noisy images using hybrid convolution and transformer neural networks. The system 10 and methods may use a deep neural network architecture (also called a “model”) that can robustly detect boundaries from a single noisy image. The model processes the input image to predict a generalized local boundary representation for each image patch called the field-of-junctions (FoJ). The FoJ can represent a variety of boundary types in image patches, including edges, corners, and contours, and is an effective prior in edge detection, especially for noisy images. By constraining the predicted boundary structures to those that FoJ can describe, the model of the present invention can detect very faint edge signals in the presence of significant noise, as illustrated in the investigation results shown in FIGS. 3A-3F. These investigations show that the system 10 and methods of the present model achieve the highest boundary detection accuracy among a variety of edge detection methods.

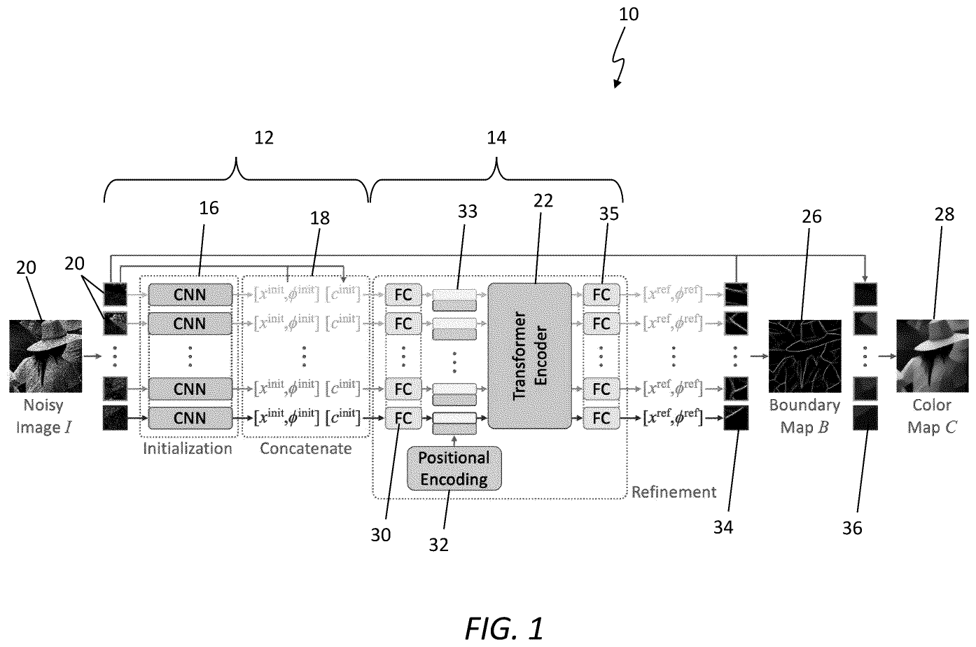

As represented schematically in FIG. 1, the digital image processing system 10 has a two-stage, hybrid convolution and transformer neural network architecture formed of two stages: an initialization stage 12 and a refinement stage 14. The initialization stage 12 has a convolutional neural network (CNN) architecture 16 that makes an initial prediction of a local FoJ parameterization solely based on the visual appearance of an individual image patch 20. The refinement stage 14 has a feedforward transformer encoder 22 that takes in the initial FoJ estimation of all image patches 20 to perform refinement. This architecture completely decomposes boundary estimation into two tasks: detecting boundaries from local image patches 20, and regularizing neighboring boundary estimations to ensure consistency and to look like natural boundaries. In the initialization stage 12, the CNN architecture 16 conducts boundary detection using a small receptive field (21×21 in the investigations). Thus, it does not need to learn the global appearance of images and can be trained using synthetic image patches that only contain basic boundary structures. In the refinement stage 14, the transformer 22 only receives the FoJ representation 18 and has no access to the input image 24 during inference. Therefore, the computational complexity of the transformer 22 in the model 10 is significantly lower than that of the conventional Vision Transformer, which uses a pure transformer applied directly to sequences of image patches 20.

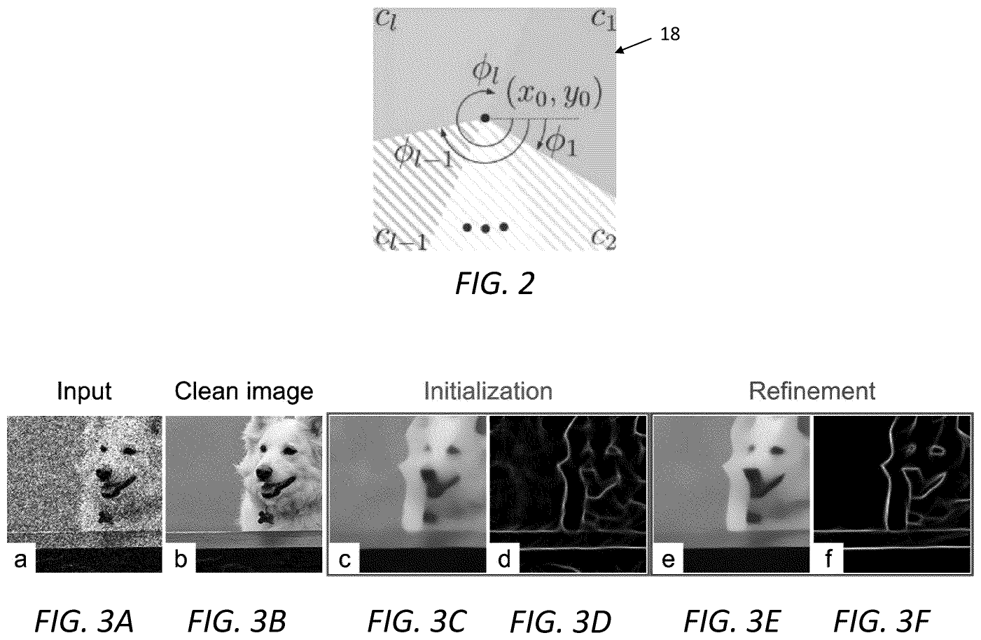

FIG. 2 depicts the FoJ representation 18 used in the model for the digital image processing system 10. In this representation, given an image patch P∈R^{h×w×k} with dimension h×w and k color channel, the FoJ models its boundary structure using a parameter set Φ=(x, ϕ, c), where x=(x₀, y₀) indicates the center of the vertex, ϕ=(ϕ₁, . . . , ϕ₁) represents the angles of the l edges, c=(c₁, . . . , cₗ), cⱼ∈R^{k}, j=1, . . . , l are the color of the region between every pair of neighboring edges. The parameter l is a hyperparameter that is predetermined. The FoJ can represent a variety of local boundary structures, including edges, corners, and junctions, as discussed in Verbin et al., “Field of Junctions: Extracting Boundary Structure at Low SNR,” Proceedings of the IEEE/CVF International Conference on Computer Vision, 2021, pp. 6869-6878, which is incorporated herein by reference in its entirety. Given an FoJ representation Φ, the corresponding boundary map of the patch B(x, y; Φ) can be plotted via:

$$B ( x , y ; Φ ) = πϵ {H}_{2 , ϵ}^{′} ( min ( {d}_{j} ( x , y ) ) ) , \qquad Eq . ( 1 )$$

where δⱼ(x, y) is the distance from the pixel (x, y) to the edge j, and H_{2,ϵ}′ is the derivative of the Heaviside function H_{2,ϵ} (see, Chan et al., “Active contours without edges,” IEEE Transactions on image processing, vol. 10, no. 2, pp. 266-277, 2001):

$${H}_{2 , ϵ} ( d ) = \frac{1}{2} ( 1 + \frac{2}{π} arctan \frac{d}{ϵ} ) , \qquad Eq . ( 2 )$$

where ϵ is a smoothing parameter set ϵ=0.01 for the investigations described herein. The color map C(x, y; Φ) can be visualized using:

$$C ( x , y ; Φ ) = {\sum }_{j = 1}^{l} {δ}_{j} ( x , y ) {c}_{j} , \qquad Eq . ( 3 )$$

where δⱼ(x, y)=1 when the pixel (x, y) is within the wedge between edge j and j+1 in the patch P:

$${Ω}_{j} = \{ ( x , y ) \vert ( x , y ) ∈ P , ( x - {x}_{0} ) cos {ϕ}_{j} + ( y - {y}_{0} ) sin {ϕ}_{j} < 0 , ( x - {x}_{0} ) cos {ϕ}_{j + 1} + ( y - {y}_{0} ) sin {ϕ}_{j + 1} > 0 \} , \qquad Eq . ( 4 )$$

and δⱼ(x, y)=0 otherwise.

Turning again to FIG. 1, the CNN architecture 16 of the initialization stage 12 contains shared-weights convolutional neural networks (CNNs) that output the FoJ representation 18 of every image patch 18. The refinement stage 14 contains the transformer encoder 22 that simultaneously refines all per-patch FoJ representations. Then, the framework 10 combines all per-patch FoJ representations together to output the global boundary map and 26 the color map 28.

More specifically, in the network architecture of the system 10, given a noisy image I∈R^{H×W×k}, the system 10 first divides the image I (e.g., image 20) into overlapping patches 20. The initialization stage 12 takes in each image patch P_{m,n} into a CNN to generate the initial vertex location and the edge angles of the FoJ representation (x^{init}_{m,n}, ϕ^{init}_{m,n}). Then, the method determines the color parameters c^{init}_{m,n}=(c^{init}_{m,n,1}, . . . , c^{init}_{m,n,l}) mathematically by averaging the color of pixels of each divided area of the patch:

$${c}_{m , n , j}^{init} = \frac{1}{\vert {Ω}_{m , n , j} \vert} {\sum }_{( x , y ) ∈ {Ω}_{m , n , j}} {P}_{m , n} ( x , y , : ) , \qquad Eq . ( 5 )$$

where Ω_{m,n,j} indicates the set of pixels in the wedge between edges j and j+1 in the patch P_{m,n}, as defined in Eq. (4).

The refinement stage 14 takes in the initial FoJ representation (x^{init}_{m,n}, ϕ^{init}_{m,n}, c^{init}_{m,n}) of all patches P_{m,n} simultaneously. It first converts each initial FoJ representation (x^{init}_{m,n}, ϕ^{init}_{m,n}, c^{init}_{m,n}) into a feature vector representation 30 v_{m,n}∈R^{d}, and applies positional encoding 32 by adding a positional vector p_{m,n}=[p_{m,n,1}, . . . , p_{m,n,d}]^{T} to the feature vector v_{m,n} to incorporate the positional information of each image patch, thereby generating positional encoded feature vectors 33. The 2D positional encoding vector follows the design of Zhang and Liu (“Translating math formula images to latex sequences using deep neural networks with sequence-level training,” International Journal on Document Analysis and Recognition (IJDAR), vol. 24, no. 1-2, pp. 63-75, 2021, the contents of which are incorporated by reference herein):

$${p}_{m , n , i} = \{ \begin{matrix}sin ( \frac{m}{{10000}^{4 i / D}} ) , i = 0 , 2 , 4 , … , d / 2 \\ cos ( \frac{m}{{10000}^{4 i / D}} ) , i = 1 , 3 , 5 , … , d / 2 + 1 \\ sin ( \frac{n}{{10000}^{4 i / D}} ) , i = d / 2 , d / 2 + 2 , … , d - 2 \\ cos ( \frac{n}{{10000}^{4 i / D}} ) , i = d / 2 + 1 , d / 2 + 3 , … , d - 1\end{matrix}$$

where the dimension of each feature vector d is an even number. All positional encoded feature vectors 33 are fed into a transformer encoder 22 that has a series of multi-head attention layers to refine the boundary consistency among patches globally and adjust unnatural boundary estimations. The transformer encoder 22 is the only block in the framework 10 that globally shares the per-patch FoJ information. Then, the framework 10 outputs refined FoJ parameters 35, including the refined vertex location and edge angles of all patches (x^{ref}_{m,n}, ϕ^{ref}_{m,n}), ∀m, n, and calculates the refined color parameters c^{ref}_{m,n} using Eq. (5). The network hyperparameters used in the investigations are listed in Table I.

TABLE 1
Model Hyperparameters
Convolutional Neural Network

| Layer | Specification | Output |
|---|---|---|
| Conv2d | 5 × 5 kernel, 4 stride, 2 pad | (21, 21, 96) |
| MaxPool2d | 3 × 3 kernel, 2 stride, 0 pad | (10, 10, 96) |
| Conv2d | 5 × 5 kernel, 1 stride, 2 pad | (10, 10, 256) |
| MaxPool2d | 2 × 2 kernel, 2 stride, 0 pad | (5, 5, 256) |
| Conv2d | 3 × 3 kernel, 1 stride, 1 pad | (5, 5, 384) |
| Conv2d | 3 × 3 kernel, 1 stride, 1 pad | (5, 5, 384) |
| Conv2d | 3 × 3 kernel, 1 stride, 1 pad | (5, 5, 256) |
| MaxPool2d | 3 × 3 kernel, 2 stride, 0 pad | (2, 2, 256) |
| FC | — | 4096 |
| FC | — | 1024 |
| FC | — | 5 |

Transformer Encoder

| Specification | Parameter |
|---|---|
| Dimension of each input vector | 128 |
| Number of layers | 8 |
| Number of heads in each layer | 8 |
| Dimension of the feed-forward layer | 256 |

As the transformer 22 does not operate on the image domain, the dimension of the input vector and the number of layers are much smaller compared to the conventional Vision Transformer.

From the refined FoJ parameters (Φ^{ref}_{m,n}, c^{ref}_{m,n}) 35, the system 10 generates the per-patch boundary map 34 and per-patch color map 36 according to Eq. (1) and Eq. (3), and computes the global boundary map B(x, y) (e.g., 26) by averaging the per-patch boundary maps:

$$B ( x , y ) = \frac{1}{N ( x , y )} {\sum }_{N ( x , y )} B ( x , y ; {Φ}_{m , n}^{ref} ) \qquad Eq . ( 6 )$$

and the global color map C(x, y) (e.g., 28) via a specific smoothing operation over the per-patch color maps:

$$C ( x , y ) = \frac{1}{\vert N ( x , y ) \vert} {\sum }_{N ( x , y )} {δ}_{m , n , j} ( x , y ) {c}_{m , n , j}^{ref} , \qquad Eq . ( 7 )$$

where N(x, y)={(m, n)|(x, y)∈Ω_{m,n,j}} is the set of the patch indices that contain (x, y), δ_{m,n,j} is a binary indicator that is 1 if pixel (x, y) belongs to the wedge Ω_{m,n,j} and 0 otherwise, and c^{ref}_{m,n,j} is the refined color of wedge Ω_{m,n,j}.

A multi-stage training scheme is used to optimize the parameters of the system 10. First, the initialization stage 12 is trained using the patch reconstruction loss:

$${L}_{init} = {E}_{P} ( MSE ( C ( x , y ; {Φ}^{gt} ) , C ( x , y ; {Φ}^{init} ) ) ) , \qquad Eq . ( 8 )$$

where E_{P} denotes the expectation over all patches in the training set, and C(x, y; Φ^{gt}) and C(x, y; Φ^{init}) indicate the per-patch color maps 36 reconstructed using true and estimated FoJ parameters, respectively. The resulting visual quality of the FoJ estimation is higher when using the loss in Eq. (8) for training than directly supervising the FoJ parameters. Furthermore, because the CNN architecture 16 of the initialization stage 12 has a small receptive field, synthetic image patches of basic shapes can be used to train it, and the resulting trained model can be generalized to real-world image patches without further fine-tuning.

When optimizing parameters of the refinement stage 14, a fixed, pre-trained initialization stage 12 is used to generate inputs Φ^{init}. A two-step training process is used for optimizing the refinement stage, which leads to a more stable and faster convergence. In the first step, a mean squared error loss function is adopted to supervise the estimated FoJ parameters directly:

$${L}_{ref 1} = {E}_{P} {‖ {x}^{gt} - {x}^{ref} ‖}^{2} + {‖ {ϕ}^{gt} - {ϕ}^{ref} ‖}^{2} . \qquad Eq . ( 9 )$$

In the second step, a comprehensive image reconstruction loss is used:

$${L}_{ref 2} = {E}_{I} ( {l}_{p} + {λ}_{b} {l}_{b} + {λ}_{c} {l}_{c} ) , \qquad Eq . ( 10 )$$

where E_{I} indicates the expectation over all images in the dataset, and lₚ, l_{b}, and l_{c} are patch, boundary, and color loss terms, respectively:

$${l}_{p} = {\sum }_{m , n} {\sum }_{j = 1}^{l} {\sum }_{x , y} {δ}_{m , n , j} ( x , y ) {‖ {c}_{m , n , j}^{ref} - I ( x , y ) ‖}^{2} ,$$

$${l}_{b} = {\sum }_{m , n} {\sum }_{x , y} {( B ( x , y ) - B ( x , y ; {Φ}_{m , n}^{ref} ) )}^{2} .$$

$${l}_{c} = {\sum }_{m , n} {\sum }_{j = 1}^{l} {\sum }_{x , y} {δ}_{m , n , j} ( x , y ) {‖ {c}_{m , n , j}^{ref} - C ( x , y ) ‖}^{2} .$$

In this way, the loss is evaluated in a single step and can successfully fine-tune the feed-forward transformer encoder to improve the FoJ representation. In contrast, other previous models solve the loss in Eq. (10) in an alternating, two-step fashion to refine the FoJ representation iteratively.

Experiments were conducted on the system 10, and results of these experiments are summarized hereinafter. For the training of the initialization stage 12, randomly sampled patches from FoJ synthetic datasets were used that only contain images of basic shapes such as squares. 8000 image patches were selected for training and 2000 for testing. To simulate image noise, a Poisson-Gaussian process was applied to each image patch:

$$P ( x , y ) = Poisson ( α P * ( x , y ) ) + Gausian ( 0 , {σ}^{2} ) , \qquad Eq . ( 11 )$$

where P (x, y) and P*(x, y)∈[0, 1] are the noisy and normalized clean image patches, α is the photon level parameter that controls the noise of the image, and σ is the standard deviation of read noise (σ=2). For the refinement stage 14, images from MS COCO were used for training and testing. The training and testing sets contained 1600 and 400 randomly selected, non-overlapping images, respectively. Each image was cropped at the center to the size of 147×147 and applied with the same noise described in Eq. (11). The photon level a was randomly set within the range [2, 10] to generate images with a variety of noise levels.

The system 10 was evaluated on the testing sets of Berkeley Segmentation Data Set 500 (BSDS500) and NYU Depth Dataset V2 (NYUDv2). The images were cropped to 147×147 size and noise was added as above. BSDS500 has 200 testing images. For NYUDv2, 200 images were randomly selected from its testing set split. Different datasets for evaluation were used to demonstrate the generalizability of the model.

Implementation of the model used l=3. All optimizations used the Adam optimizer. The initialization stage 12 was trained with an initial learning rate of 0.0002 and a decay of 0.5 every 80 epochs. The batch size was 32, and the total number of training epochs was 900. A two-step scheme was used to train the refinement stage 14 as described as described previously herein. Both steps used a batch size of sixteen. The first step used Eq. (9) as the objective function and had 100 epochs and exhibited a learning rate 5×10⁻⁵. The second step switched to Eq. (10) as its loss function and ran 1600 epochs. The learning rate for the second step was updated with a triangular cycle between 1.75×10⁻⁴ and 3.5×10⁻⁴. The training and testing were performed on a machine with an NVIDIA Geforce RTX A5000 graphics card and 24 GB memory. The fixed contour threshold (ODS) F1-score was recorded during evaluation, with a non-maximum suppression applied in advance. The localization tolerance was adjusted proportionally to accommodate the image size in the experiment, setting it to 0.0209 for BSDS500 and 0.0372 for NYUDv2.

In an ablation study, the benefit offered by the refinement stage 14 of the system 10 was investigated. As seen in the series of images in FIGS. 3A-3F, the refinement stage 14 attenuates noisy and inconsistent boundary estimations and strengthens real boundaries compared to the boundary map from the initialization stage 12. FIGS. 3A and 3B are the input noisy image and the corresponding clean image, respectively, from the MS COCO dataset. FIGS. 3C and 3D are the color map and boundary map, respectively, before the refinement stage 14. FIGS. 3E and 3F are the color map and boundary map, respectively, after the refinement stage 14. From these images, it can be seen that in the refinement stage 14, noisy edge estimations are removed, and the color map 28 is smoother. The refinement stage 14 also makes the color map 28 appear smoother and sharper at color boundaries. These results show that the system 10 has robustness to the high noise level and can detect faint boundaries that are visually invisible. Quantitative analysis similarly shows that the refinement stage 14 increases the ODS F1-score of the boundary map compared to the initialization stage 12.

As reported in Wei Xu, Junjie Luo, and Qi Guo, CT-Bound: Robust Boundary Detection from Noisy Images Via Hybrid Convolution and Transformer Neural Networks, submitted to Cornell University's open-access archive, arXiv.org, on Mar. 25, 2024, and submission revised Jun. 25, 2024, available at https://doi.org/10.48550/arXiv.2403.16494, analysis was performed on synthetic and real images using the system 10 in comparison to analysis performed on the same synthetic and real images using various preexisting learning-based models, including a conventional iterative FoJ solver and a traditional edge detector Canny. The system 10 showed robustness to high noise levels and was able to detect faint boundaries that were visually invisible. Quantitative comparisons of results obtained with the system 10 and the preexisting learning-based models showed that the system 10 achieved the highest or near-highest ODS F1-score when the noise level is very high, i.e., α=2. Both results indicated the robustness and generalizability of the method to different image datasets and noise levels.

From the results of the investigations, it was concluded that, in comparison to a variety of prior known models, the system 10 and method of the present invention demonstrated the highest or near-highest boundary detection accuracy on benchmark datasets, producing visually clean and crisp boundaries. Further, in comparison to known methods based on local attention that infer unrasterized boundaries, the system 10 is capable of focusing on boundary detection to achieve a higher boundary detection accuracy on benchmark datasets with a three-times faster speed. The system 10 provided a robust and fast and non-iterative solver of FoJ that enabled real-time boundary detection on very noisy images.

As previously noted, though the foregoing detailed description describes certain aspects of particular embodiments of the invention, alternatives could be adopted by one skilled in the art. For example, functions of certain components of the system 10 could be performed by components of different construction but capable of a similar (though not necessarily equivalent) function. As such, and again as was previously noted, it should be understood that the invention is not necessarily limited to any particular embodiment described herein or illustrated in the drawings.

1. A two-stage hybrid computer-implemented neural network architecture for a digital image processor, the two-stage hybrid computer-implemented neural network architecture comprising:
an initialization stage comprising a convolutional neural network architecture; and
a refinement stage comprising a feedforward transformer encoder;
wherein the convolutional neural network architecture is configured to generate initial field-of-junctions parameters for each of a plurality of image patches of an input image; and
wherein the feedforward transformer encoder receives the initial field-of-junctions parameters and refines simultaneously each of the received initial field-of-junctions parameters to output refined field-of-junctions parameters for each of the image patches.

2. The two-stage hybrid computer-implemented neural network architecture of claim 1, wherein the initial field-of-junctions parameters comprise initial vertex locations and initial edge angles, and wherein the refined field-of-junctions parameters comprise corresponding refined vertex locations and refined edge angles for each of the initial vertex locations and initial edge angles.

3. The two-stage hybrid computer-implemented neural network architecture of claim 1, wherein the refinement stage is configured to generate a boundary map for each image patch from the corresponding refined field-of-junctions parameters for each of the image patches.

4. The two-stage hybrid computer-implemented neural network architecture of claim 1, wherein the initialization stage is configured to determine an initial color parameter of each image patch by averaging colors of pixels of each divided area of the image patch.

5. The two-stage hybrid computer-implemented neural network architecture of claim 4, wherein the refinement stage is configured to generate a color map for each image patch from the corresponding initial color parameters for each of the image patches.

6. The two-stage hybrid computer-implemented neural network architecture of claim 1, wherein the feedforward transformer encoder comprises a series of multi-head attention layers configured to refine boundary consistency among the image patches globally and adjust unnatural boundary estimations.

7. The two-stage hybrid computer-implemented neural network architecture of claim 1, wherein the feedforward transformer encoder globally shares the initial field-of-junctions parameters of all the image patches.

8. The two-stage hybrid computer-implemented neural network architecture of claim 7, wherein the feedforward transformer encoder is the only component of the two-stage hybrid computer-implemented neural network architecture that globally shares the initial field-of-junctions parameters of all the image patches.

9. The two-stage hybrid computer-implemented neural network architecture of claim 1, wherein each image patch is a smaller division of the input image, wherein borders of adjacent image patches overlap each other, and wherein the image patches collectively comprise the entire input image.

10. The two-stage hybrid computer-implemented neural network architecture of claim 9, wherein the initialization stage is configured to divide the input image into the overlapping image patches.

11. A digital image processor comprising the two-stage hybrid computer-implemented neural network architecture of claim 1.

12. The digital image processor of claim 11, further comprising means for computing a global boundary map of the entire input image from the boundary maps of all the image patches.

13. The digital image processor of claim 11, further comprising means for computing a global color map of the entire input image from the color maps of all the image patches.

14. A method of training the two-stage hybrid computer-implemented neural network architecture of claim 1, the method comprising:
training the initialization stage using patch reconstruction loss; and
after training the initialization stage, optimizing the refinement stage to generate inputs for the field-of-junctions parameter estimations by:
supervising the field-of-junctions parameter estimations directly with a mean squared error loss function; and
implementing a comprehensive image reconstruction loss in a single step to fine-tune the feed-forward transformer encoder to improve the field-of-junctions parameter estimations.

15. The method of claim 14, wherein training the initialization stage using patch reconstruction loss comprises using synthetic image patches of basic shapes to train the initialization stage.

16. The method of claim 14, wherein the trained model is generalized to real-world image patches without further fine-tuning.

17. A computer-implemented method of estimating a boundary in a digital image, the method comprising:
dividing an input image into a plurality of overlapping image patches;
using a convolutional neural network architecture, generating for each image patch initial field-of-junctions representations comprising initial vertex locations, initial edge angles, and initial color parameters; and for each image patch:
converting the initial field-of-junctions representations into feature vector representations;
generating positional encoded feature vectors by applying positional encoding comprising adding a positional vector to the feature vector representations to incorporate positional information of each image patch; and
generating refined image patches by providing all the positional encoded feature vectors to a feedforward transformer encoder to simultaneously refine boundary consistency among the image patches globally, adjust unnatural boundary estimations, and calculate refined color parameters for each image patch.

18. The computer-implemented method of claim 17, wherein the step of generating the refined image patches comprises:
globally sharing the initial field-of-junctions representations for all of the image patches within the feedforward transformer encoder; and
using the feedforward transformer encoder, generating refined vertex locations and edge angles for each image patch.
